(19) United States
(12) Patent Application Publication
(10) Pub. No.: US 2008/0035020 A1
(43) Pub. Date: Feb. 14, 2008

(54) Moldable paste and method of using the paste

(76) Inventor: Heinrich Schnorrer, Schwandorf (DE)

Correspondence Address: Friedrich Kueffner, Suite 910, 317 Madison Avenue, New York, NY, 10017, US

(21) Appl. No.: 11/890,320

(22) Filed: Aug. 4, 2007

(30) Foreign Application Priority Data
Aug. 8, 2006 (DE) 10 2006 036 993.9

(51) Int. Cl. B28B 7/36; H05B 6/64

(52) U.S. Cl. 106/38.22; 264/432

(57) ABSTRACT

A moldable paste includes at least water, binding agent and filler, wherein the binding agent is a cellulose ether with a high etherification degree. The cellulose ether may have an etherification degree with an average substitution degree greater than 1.5. The paste may contain at least 5 to 65% by weight water, 0.1 to 25% by weight cellulose ether, 0.5 to 35% by weight fillers, and 0.1 to 10% by weight salt.

### BACKGROUND OF THE INVENTION

1. Field of the Invention

The present invention relates to a moldable paste according to the principal claim, as well as a method of using the paste.

The moldable paste refers to an air-drying moldable paste which can be introduced into heat furnaces for accelerated solidification or hardening or which can alternatively be hardened using rays as an energy source.

2. Description of the Related Art

From DE 10 2004 039 270 A1 a moldable paste is known which is dried and hardened through the induction of energy from energy sources, wherein the energy source for the hardening of the paste is a microwave apparatus.

The described paste has at least one component of high porosity. This component is an inorganic component like lime hydrate, pearlite or bentonite.

It is disadvantageous in such a paste that the surface quality after the drying process is poor, i.e., uneven and rough. This is, in part, caused by the fact that the not yet hardened paste already shows unevenness during the smoothing on the modeled surface.

Furthermore, air-drying and furnace-hardening plastic pastes are known. It is disadvantageous in these pastes that even in small models drying and hardening at room temperature all the way to the complete drying or solidification takes at least 24 hours. In larger pieces the drying process can take up to several days. It has been proven that for such pastes even at accelerated drying in an oven a hardening period of several hours is required.

Tests to dry or harden such water-based moldable pastes in the microwave have lead to the result that the paste first hardens at its surface which makes it impossible for steam to diffuse from the inside of the model to the outside. The steam pressure on the inside of the model causes fissures and bubbles at the surface of the models which, in turn, gives the models an unsightly look and they become unstable. In an extreme case, the steam pressure can blast the model.

A further disadvantage is that the models produced from such pastes shrink overall at least 4-10% during air-drying or oven-drying. Furthermore, it has become apparent that thinner designed models with layer thicknesses of up to 5 mm have a high tendency to warping during the drying process.

### SUMMARY OF THE INVENTION

Therefore, it is the object of the present invention to create a water-based moldable paste which does not have the described disadvantages, wherein models produced from such a paste can be fully dried and hardened within a few minutes without the appearance of fissures and bubbles and, furthermore, high surface quality is guaranteed.

This object can be solved in a simple manner with a moldable paste including at least water, binding agent and filler, wherein the binding agent is cellulose ether, the improvement comprises that the binding agent is a cellulose ether with a high etherification degree.

The pastes according to the invention are composed at least of water, binding material, filler and salt, as well as possible additives like preservatives, evaporation retarders and colorants.

The requirements with respect to the paste are met by adding a cellulose ether, methyhydroxyethyl cellulose (MHEC) or methyhydroxypropyl cellulose (MHPC) with a high etherification degree. The etherification degree is indicated by a so-called DS-number. DS, in this content, means average substitution degree. It indicates the average number of etherized hydroxyl groups of an anhydroglucose unit of the cellulose. The maximum number for DS is 3. Cellulose ether with a DS greater than 1.5 is considered highly etherized.

The content of cellulose ether in the paste flocculates in warm conditions which prevents the formation of a closed layer on the surface of the paste during drying in the microwave which, in turn, would make it impossible for the steam to exit from the interior of the modeling paste through micro channels. The process of flocculation starts at approximately 40° C., in dependence on the average substitution degree DS. In this way, there occurs no blistering or crack formation at the surface due to steam pressure. In connection with flocculation, one also speaks of a so-called thermal gelification. The thermal gelification is supported by adding salts like, for example, calcium chloride. Preferably, salts with monovalent cations like, for example, sodium chloride, are used.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### DESCRIPTION OF PREFERRED EMBODIMENTS

Several embodiments of the invention are hereafter described in more detail.

Basic example for a moldable paste:

| | |
|---|---|
| Water | 5.0-65% by weight |
| Cellulose ether (BM1) | 0.1-25% by weight |
| Fillers | 0.5-35% by weight |
| Salt | 0.1-10% by weight |
| Plastic dispersion (BM2) | 0-40% by weight |
| Colorant | 0-10% by weight |
| Preservative (KM) | 0-2% by weight |
| Evaporation retarder (VZ) | 0-10% by weight |

### Example 1

### Modeling Paste Terracotta

| | |
|---|---|
| Water | 56.4% by weight |
| Methyhydroxyethyl cellulose (BM1) | 8.0% by weight |
| Polyacrylate | 9.0% by weight |
| Micro glass hollow spheres | 19.0% by weight |
| Sodium chloride | 2.0% by weight |
| Paraffin oil (VZ) | 5.0% by weight |
| Pigment red 101 | 0.5% by weight |
| 2-brom-2-nitropropane-1.3-diol KM) | 0.1% by weight |

### Example 2

### Modeling Paste White

| | |
|---|---|
| Water | 64.0% by weight |
| Methyhydroxyethyl cellulose (BM1) | 9.0% by weight |
| Micro glass hollow spheres | 22.0% by weight |
| Calcium chloride | 2.0% by weight |
| Glycerin (VZ) | 2.8% by weight |
| Sorbic acid (KM) | 0.2% by weight |
| 2-brom-2-nitropropane-1.3-diol KM) | 0.1% by weight |

The water in the paste can be added as pure water or it can result from the added plastics dispersion, the binder material (BM2). In example 1, for example, 18% by weight of a 50 percent plastics dispersion were added which equals a dry content of plastic of 9% by weight.

As fillers are preferably used spherical or globular inorganic materials. An example for this are micro glass hollow spheres with a particle size smaller than 150 μm.

The models or objects produced with the paste according to the invention can be placed in a standard microwave apparatus and are dried and hardened within minutes by the radiation produced therein.

Furthermore, it has proven advantageous that moldable pastes which have additional synthetic organic binder materials (BM2) show an even better plasticity or moldability. As a second binder material can be used synthetic organic binders like, for example, polyurethane and/or polyacrylate which are water-soluble, water-insoluble or water-dispersible. Preferably, these synthetic binder materials are used as aqueous dispersion.

It has been demonstrated that pastes containing BM2 in a hardened state have a higher breaking strength and a higher folding flexibility.

A further advantage which has been demonstrated is that the modeling paste after hardening in the microwave has a considerably lower density than in the non-hardened state. This causes the models to become lighter after hardening and they are even floatable. The density of the paste in a non-hardened state is approximately 1.05 to 1.5 g/ml and the density in the hardened model is approximately 0.70 to 0.95 g/ml.

In the drying of objects and artifacts which were produced with the paste according to the invention, extremely short hardening periods in the microwave could be established.

Furthermore, it has become apparent that by adding evaporation retardant substances like, for example, glycerin, paraffin oil, sugary substances and/or glycols, the hardening speed of the paste according to the invention can be regulated or adjusted.

As a further additive, the paste according to the invention can also contain pH-regulators. One example for this would be potassium alum.

An example of the particular advantage of hardening by way of microwave radiation is shown in the following table.

| Initial | Sphere | | Hardening | |
|---|---|---|---|---|
| paste | diameter | Output | time | End weight |
| (grams) | (cm) | (watts) | (min) | (grams) |
| 20 | 3 | 400 | 6 | 13 |
| 20 | 3 | 800 | 3 | 13 |
| 40 | 4 | 800 | 4 | 26 |
| 80 | 5 | 800 | 5 | 52 |
| 160 | 6 | 800 | 8 | 104 |

As preservatives, only to mention a few examples, a 0.5 percent solution of 2-brom-2-nitropropane-1.3-diol or a 0.3 percent mixture of 5-chlor-2-methyl-2H-isothiazole-3-on and 2-methyl-2H-isothriazol-3-on can be used.

The colorant added to the paste, where applicable, can be powder pigments or aqueous pigment preparations. Representative for a multitude of applicable pigments, a few were mentioned in the examples. Frequently, titanium dioxide is used as a color-producing medium. There is practically no limit to the use of color pigments.

The production of modeling pastes according to the invention can be carried out with the usual equipment, in particular in conventional mixers. The components are blended, kneaded and subsequently extruded in a mixer. Subsequently the paste is packaged airtight.

Such a modeling paste is used in model or prototype construction, since samples and models or entire model landscapes can be produced true to scale because no shrinkage occurs during hardening.

Furthermore, such a model paste is used in the pastime and artistic field, for the production of, for example, decorative articles, dolls, doll heads, masks and many more objects. There is no limit to its use for creating models in the pastime and artistic fields.

The use of modeling paste is also equally recommended in modeling workshops for adults, schools and nursery schools, since the models produced in the workshop, at school or in nursery school can be hardened in a matter of minutes and thus can be immediately taken home by their respective creator.

A further possible use of the paste according to the invention is as sealing medium and as insulation or casting paste.

While specific embodiments of the invention have been shown and described in detail to illustrate the inventive principles, it will be understood that the invention may be embodied otherwise without departing from such principles.

1. In a moldable paste including at least water, binding agent and filler, wherein the binding agent is cellulose ether, the improvement comprises that the binding agent is a cellulose ether with a high etherification degree wherein the cellulose ether has an etherification degree with an average substitution degree greater than 1.5, and wherein the paste contains salt as another component.

2. (canceled)

3. The paste according to claim 1, wherein the paste contains at least
5-65% by weight water
0.1-25% by weight cellulose ether (BM1)
0.5-35% by weight fillers
0.1-10% by weight salt.

4. A method of producing models and/or prototypes, wherein the models and/or prototypes are made of a moldable paste comprised of at least water, binding agent and filler, wherein the binding agent is a cellulose ether with a high etherification degree.

5. A method of producing sealing agent, insulation and/or casting paste, wherein the sealing agent, insulation and/or casting paste is made of a moldable paste comprised of at least water, binding agent and filler, wherein the binding agent is a cellulose ether with a high etherification degree.

6. A process for hardening a moldable paste, wherein the moldable paste is comprised of at least water, binding agent and filler, wherein the binding agent is a cellulose ether with a high etherification degree, further comprising hardening the paste with microwave energy.
